(19) United States
(12) Patent Application Publication
(10) Pub. No.: US 2018/0109122 A1
(43) Pub. Date: Apr. 19, 2018

(54) ENERGY ACCUMULATOR DEVICE

(71) Applicant: Hella KGaA Hueck & Co., Lippstadt (DE)

(72) Inventor: Andre KOERNER, Lippstadt (DE)

(21) Appl. No.: 15/560,349

(22) PCT Filed: Mar. 16, 2016
(86) PCT No.: PCT/EP2016/055685

§ 371 Date: Sep. 21, 2017

(30) Foreign Application Priority Data
Mar. 23, 2015 (DE) 10 2015 104 293.2

(51) Int. Cl. H02J 7/00; H01M 10/48; B60R 16/033; H02M 3/155

(52) U.S. Cl. CPC H02J 7/0024; H01M 10/482; H02M 3/155; H02J 7/0021; B60R 16/033

(57) ABSTRACT

An energy accumulator device for connecting a first voltage network with a first voltage level to at least one second voltage network with a second voltage level, wherein the first voltage level is higher than the second voltage level, wherein there is a plurality of module strings, in each of which a number of battery cell modules are provided and interconnected. The module strings can be connected to each other in parallel, wherein in each module string is a plurality of the battery cell modules which can be interconnected with each other alternately in parallel or in series via switching elements.

### TECHNICAL FIELD

The invention relates to an energy accumulator device, in particular for a motor vehicle with a plurality of voltage levels. The invention also relates to a motor vehicle of this type.

### STATE OF THE ART

Motor vehicles are becoming ever more electrified, for example in order to be driven electrically. Ever more units are also provided in the motor vehicle which, instead of being operated either at the usual vehicle electrical system voltages of 12V or 24V or at high voltage, are operated at a further voltage level below 60V DC voltage.

The transfer of electrical energy from vehicle electrical systems with a higher voltage than the vehicle electrical system voltage of 12V or 24V usually used in motor vehicles in the case of heavy goods vehicles in Europe requires a corresponding impedance bridging. So-called DC-to-DC converters are used for this in the state of the art. The power design of the DC-to-DC converters is directed towards the power and energy required in the 12V vehicle electrical system as all of the electrical energy generated at higher voltage in the vehicle electrical system must be transferred to this voltage level by means of the DC-to-DC converter.

DC-to-DC converters are constructed in a complex and expensive manner, i.e. they have relatively large, heavy and expensive electronic power assemblies.

The expense of the voltage conversion is high due to the complexity and the required power design of the DC-to-DC converters. The broad introduction of, for example, a 48V hybridization of vehicles driven by internal combustion engines, which has substantial potential to reduce the vehicle fleet consumption of CO2, is thereby made difficult. The voltage conversion by means of DC-to-DC converters, as provided for the vehicle electrical system topology in the case of 48V mild hybrid vehicles, does not make sufficient use of the specific conditions, rather they use architecture that is usual in the case of high-voltage hybrid vehicles, but with the simplification that the DC-to-DC converters no longer need to be designed galvanically isolated.

### REPRESENTATION OF THE INVENTION, OBJECT, SOLUTION, ADVANTAGES

The object of the invention is to develop an energy accumulator device which is constructed simply and is improved compared with the state of the art. Accordingly, a device is to be developed which allows the transfer of energy between not galvanically isolated vehicle electrical systems of different voltages using comparatively simple means. The object is also to develop a motor vehicle of this type.

The object of the energy accumulator device is achieved with the features of claim 1. The object of the motor vehicle is achieved with the features of claim 20.

An embodiment example of the invention relates to an energy accumulator device for connecting a first voltage network with a first voltage level to at least one second voltage network with a second voltage level, wherein the first voltage level is higher than the second voltage level, wherein there is a plurality of module strings, in each of which a number of battery cell modules are provided and interconnected, wherein the module strings can be connected to each other in parallel, wherein in each module string there is a plurality of battery cell modules which can be interconnected with each other alternately in parallel or in series via switching elements. It is thereby achieved that, in multi-voltage vehicle electrical systems with a common earth, separate batteries for the individual partial electrical systems or voltage networks and DC-to-DC converters for transferring energy between the partial electrical systems can be dispensed with, or alternatively the batteries or DC-to-DC converters still used can be formed much smaller. It is also advantageous for it to be possible to continuously provide two different supply voltages of the two voltage networks at the same time, wherein the actual power requirement in the respective voltage network can still be taken into account. For this, there is no need for additional and complex energy accumulator and energy converter components.

In addition, the expense of realizing and controlling and/or monitoring the series and/or parallel connection of the battery cell modules is much lower than the expense of a DC-to-DC converter. The expense of implementing a multi-voltage vehicle electrical system can thereby be significantly reduced. The installation space required for the accumulators and converters of the multi-voltage vehicle electrical system can likewise be significantly lowered, whereby the multi-voltage battery can ideally be housed in the installation space of the single-voltage battery that has been usual until now, which greatly simplifies the introduction of a dual-voltage vehicle electrical system.

In a further embodiment example it is expedient if the module strings can be connected to each other in parallel, wherein on the input side each module string has a switch, by means of which the module string can be switched on. One module string or the other can thereby be switched on or off respectively, with the result that, depending on the power requirement in the respective voltage networks, which can also be called vehicle electrical systems, the respective switching on or off of the corresponding module string under consideration can be switched on or off.

In an advantageous embodiment example it is also advantageous if at least two module strings are arranged and can be connected in parallel relative to each other, in particular two to four module strings are provided and can be connected to each other in parallel. The voltage supply of the voltage networks can thereby be adapted simply to the respective power requirement.

According to a further advantageous embodiment example it is particularly advantageous if a control device is provided which monitors the power requirement and the status of the voltage networks and, based on the requirement, switches the individual module strings on or off, or dynamically determines the number of module strings switched on or off and controls them accordingly. This simplifies and optimizes the control of the module strings depending on the respective, optionally also only short-term, requirement.

It is particularly advantageous if the battery cell modules in a module string can be interconnected with each other in parallel via first switches and can be interconnected with each other in series via second switches.

It is also advantageous if the control device is formed such that it monitors the power requirement and the status of the voltage networks and, based on the requirement, controls the switches of the individual module strings in order to interconnect the battery cell modules with each other in parallel via the first switches and/or to interconnect them with each other in series via the second switches.

Through the use of several switchable energy accumulators, the availability of electrical energy can be ensured much more reliably even in the event of failure of individual energy accumulator elements, whereby safety-sensitive functions, such as e.g. operation with an idling generator during so-called coasting, are safeguarded.

It is particularly advantageous if the battery cell modules or at least individual battery cell modules are connected to the lower positive voltage level of the second voltage network by means of switches.

It is also advantageous if the battery cell modules or at least individual battery cell modules are connected to the negative voltage level, such as the earthing level of the second voltage network, by means of switches. It is furthermore advantageous if first battery cell modules are interconnected in series with second battery cell modules by means of switches, wherein the negative terminal of the first battery module can be connected to the positive terminal of the second battery module by means of the switch.

It is particularly advantageous if first battery cell modules are interconnected in series with second battery cell modules by means of switches, wherein the negative terminal of the first battery module can be connected to the positive terminal of the second battery module by means of the switch. This makes adaptation to the voltage level of the voltage network with the higher voltage level possible.

It is furthermore particularly advantageous if the second voltage network is connected to a battery cell module directly or via a switch.

It is particularly advantageous if the first voltage network with its first positive voltage level is connected to a battery cell module between its positive terminal and the switch. It is also advantageous if a starter, a generator and/or a starter generator are provided in the first and/or in the second voltage network. An expedient energy recovery and/or an advantageous support of the drive can thus be carried out.

It is also expedient if a further battery which can be connected with its positive terminal to the positive terminal of a battery module by means of a switch is provided in the first voltage network.

It is also advantageous if the switches are mechanical or electrical or electronic switches. They can thus preferably be operable by a control unit in an automated manner.

It is therefore expedient if the switches can be switched by a control device. Switching can thus be carried out based on the requirement.

It is furthermore advantageous if individual or all battery modules are assigned measuring devices which determine the charging and discharging currents, the voltages at the battery modules and/or at the battery cells and/or the temperatures there.

A DC-to-DC converter can additionally connect the two voltage networks.

Further advantageous embodiments are described by the following description of the figures and by the dependent claims.

### BRIEF DESCRIPTION OF THE DRAWINGS

The invention is explained in more detail below on the basis of at least one embodiment example with reference to the drawings. There are shown in:

FIG. 1 a circuit diagram of a conventional multi-voltage vehicle electrical system with two voltage levels,

FIG. 2 a circuit diagram of a multi-voltage vehicle electrical system with two voltage levels with circuitry according to the invention,

FIG. 3 a circuit diagram of a multi-voltage vehicle electrical system with two voltage levels with circuitry according to the invention,

FIG. 4 a circuit diagram of a multi-voltage vehicle electrical system with two voltage levels with circuitry according to the invention, and

FIG. 5 a circuit diagram of a multi-voltage vehicle electrical system with two voltage levels with circuitry according to the invention.

### PREFERRED EMBODIMENT OF THE INVENTION

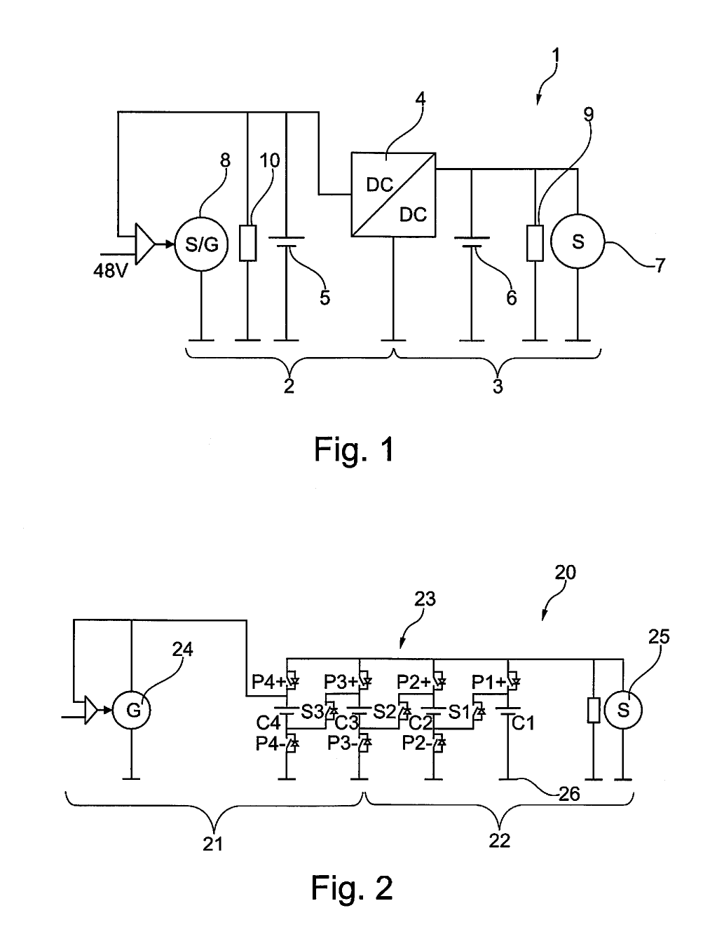

FIG. 1 shows the circuitry of a multi-voltage vehicle electrical system 1. Multi-voltage vehicle electrical systems 1, as shown in FIG. 1 as a dual-voltage vehicle electrical system, have two voltage regions 2, 3 which are separated by a DC-to-DC converter 4. By way of example, a dual-voltage vehicle electrical system is shown in FIG. 1 which is represented as a 48V/12V dual-voltage vehicle electrical system. This is suitable in particular for motor vehicles. For both voltage regions 2, 3 (48V and 12V), in each case, one battery 5, 6 and, to couple the voltage levels, a DC-to-DC converter 4 are provided. A starter 7 is provided in the 12V partial electrical system 3. In the 48V partial electrical system 2 there can also be a starter/generator 8; otherwise only a generator is alternatively provided there.

Consumers 9 are arranged in the 12V partial electrical system 3. However, particularly power-intensive consumers 10 can in particular also be present in the 48V partial electrical system 2. A redundant powering of safety-sensitive applications in the 12V partial electrical system 3 can be effected by the 12V battery 6 and the 48V battery 5 via the DC-to-DC converter 4. The electric generator 8 in the 48V partial electrical system 2 is suitable in particular for recovering kinetic energy from deceleration processes of the vehicle. Alternatively or additionally, the generator 8 could also be operable as an electric motor for driving, with the result that it can be used both to start the internal combustion engine and to support its torque.

FIG. 2 shows an embodiment example of the invention with reference to circuitry. Two partial electrical systems 21 and 22 are represented here, which are again represented, for example, as 48V partial electrical system 21 and 12V partial electrical system 22. However, this is only an embodiment example and in no way represents a restriction of the invention.

The DC-to-DC converter with the two batteries 5, 6 according to FIG. 1 is here replaced with a network 23 of battery cell modules C1, C2, C3, C4 with a circuitry of electrical or electronic switches P1+, P2+, P3+, P4+, P1−, P2−, P3−, P4−, S1, S2, S3.

The battery cell modules C1, C2, C3, C4 advantageously consist in each case of a series connection and optionally parallel connection of individual cells, wherein their voltage corresponds in each case to the voltage in the partial electrical system with lower voltage.

The battery modules C1, C2, C3, C4 are interconnected by means of electrical or electronic switches P1+, P2+, P3+, P4+, P1−, P2−, P3−, P4−, S1, S2, S3 such that they are alternately operated in parallel and series connection or a combination thereof.

The battery modules are coupled to the partial electrical system 2 with the higher voltage in a series connection, wherein the battery modules are coupled to the partial electrical system 3 with the lower voltage in a parallel connection.

If the voltage in the partial electrical system 2 with the higher voltage is to assume different voltage levels at different multiples of the lower voltage, the switching between series and parallel connection can intermittently also be effected only partially, with the result that a partial quantity of the battery cell modules are connected between earth potential and the low voltage and a further partial quantity of the battery cell modules are connected between the low voltage and the higher voltage.

At least individual or several thus-formed battery modules 30, 31, 32, 33 can be combined by connecting their respective connections on the partial electrical systems to each other and, at the same time and/or in particular temporally offset, switched between series and parallel connection.

The generator 24 is connected to one of the two partial electrical systems 21, 22, here into the partial electrical system 21, wherein it can also be connected to the partial electrical system 22. It can thus advantageously be connected to one of the two partial electrical systems 21, 22 depending on the respective operation situation by means of electrical or electronic switches.

A battery cell module C1, which is connected to the electrical earth connection 26 of the vehicle, can be connected, at its other connection, securely to the partial electrical system 22 with low voltage, or alternatively, as shown, can be coupled to the partial electrical system 22 with low voltage by means of an electrical or electronic switch P1+. In this case, the battery cell module C1 can be decoupled from the partial electrical system 22 again. Alternatively, an electrical resistance can also be used instead of the switch P1+.

It is advantageous if the battery cell modules or at least individual ones of the battery cell modules are equipped with one or more current, voltage and/or temperature sensors, for example, for monitoring, control and/or regulation.

The device according to the invention is formed as a multi-voltage battery and can advantageously be connected to individual or several partial electrical systems which contain further batteries, as well as other energy accumulators, such as for example supercaps or the like.

The device according to the invention as a multi-voltage battery can also be supplemented by DC-to-DC converters between the two partial electrical systems 21, 22 for additional energy transfer and the at least intermittent supply of energy to or support of the partial electrical systems 21, 22.

In a simple embodiment of the device 20 according to the invention, the two batteries 5, 6 and the DC-to-DC converter 4 according to FIG. 1 are replaced with four battery cell modules C1, C2, C3 and C4, the switches for parallel connection P1+ to P4+ and P2− to P4− and the switches for series connection S1, S2, S3. The switches are represented as separate switches in FIG. 2. However, they can also be formed as toggle switches or as multiple toggle switches. The switches P1+ to P4+, P2− to P4− and S1, S2, S3 can be formed as electromechanical switches or as electronic switches, for example as power MOSFETs. The actuation of the switches is effected automatically synchronously without intervention by the driver, controlled by energy management through a control device for this purpose.

The circuitry is such that the respective switch Px+ where x=1, 2, 3 or 4 connects the respective battery Cx where x=1, 2, 3 or 4 to the positive voltage level of the partial electrical system 22 and the respective switch Px− where x=1, 2, 3 or 4 connects the respective battery Cx where x=2, 3 or 4 to the negative voltage level of the partial electrical system 22 or the earth level. Furthermore, the negative terminal of the battery Cx is connected to the positive terminal of the battery Cx−1 by means of the switch Sx−1, thus for example the negative terminal of the battery C4 is connected to the positive terminal of the battery C3 with the switch S3 and so on.

In most operation situations, the P switches are closed and the S switches are opened. The battery cell modules C1 to C4 are thus connected in parallel and power the 12V partial electrical system 22. In this operation situation the generator 24 is likewise operated in the 12V partial electrical system 22 and generates electrical energy as required from the kinetic energy from the drive train. During sufficiently strong deceleration processes of the vehicle or during acceleration processes which are to be electrically supported, there is a switch from the parallel connection to the series connection of the battery cell modules. The electric motor/generator 24 is switched on in these operation situations at the end of the series connection, and can there deploy its maximum power.

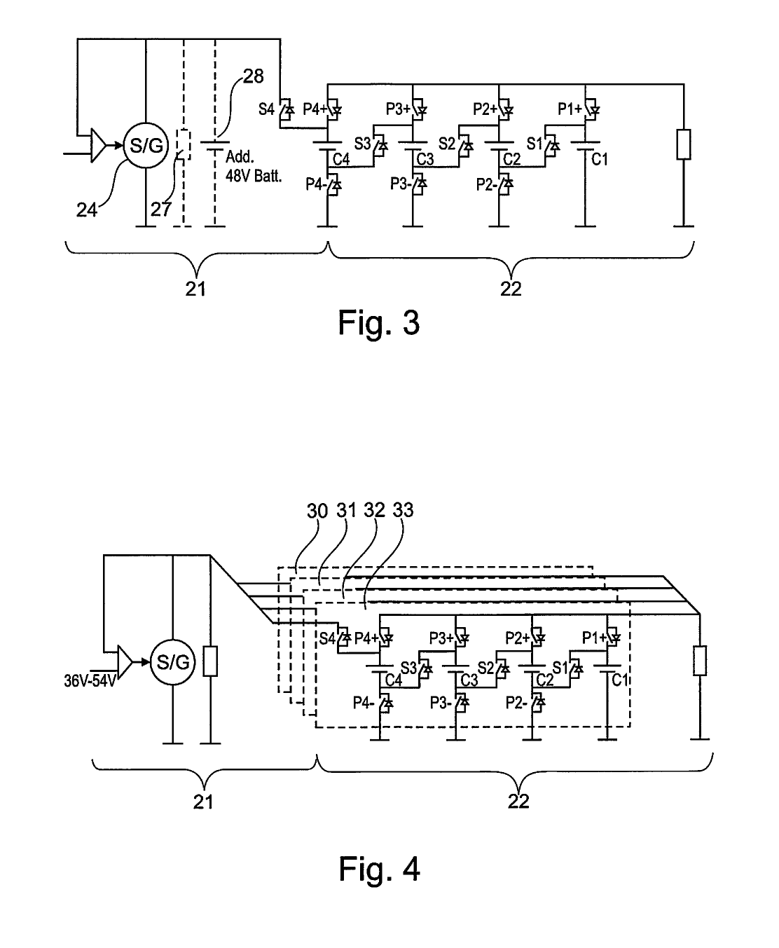

In the case of higher power requirements in the 48V vehicle electrical system 21 by additional consumers 27, an additional 48V battery 28 can also be introduced. The additional battery and the 48V consumers 27 and/or the electrical machine 24 can then also be coupled via an additional switch S4, see FIG. 3.

A further embodiment according to the invention, see FIG. 4, provides the use of several battery switching modules in several module strings 30, 31, 32, 33, which are connected to the first voltage network 21, such as for example the 48V partial electrical system, and to the second voltage network 22, such as for example the 12V partial electrical system 22. The respective module strings are constructed identically and they are constructed such as is described in relation to FIG. 3. In each case they have four battery cell modules C1 to C4, which are interconnected by means of switches Px+ and Px− where x=1, 2, 3 and 4. On the input side, the respective module string 30, 31, 32, 33 is connected to the first voltage network 21 via the switch S4, while the respective module string 30, 31, 32, 33 is connected to the second voltage network 22 via the respective switch P1+.

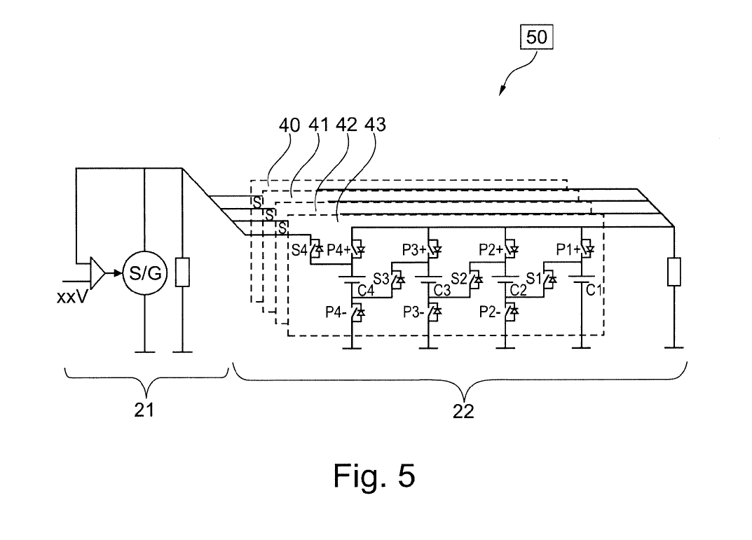

According to a further, alternative embodiment of the invention, according to FIG. 5 the arrangement is represented which substantially corresponds to the representation of FIG. 4, wherein the four module strings 40, 41, 42 and 43, which substantially correspond to the module strings 30 to 34 of FIG. 4, are arranged, not one above the other, but perspectively offset. The module strings 40, 41, 42 and 43 in each case have only three battery cell modules C2, C3 and C4, which are interconnected by means of the switches Px+ and Px−, where x=2, 3 and 4. On the input side, the respective module string 40, 41, 42, 43 is again connected to the first voltage network 21 via the switch S4.

The switch P1+ and the battery cell module C1 are arranged outside the respective module string 40, 41, 42, 43, as can be seen in FIG. 5. Alternatively, the switch P1+ can also be omitted, wherein then the battery cell module C1 can then be interconnected with the other remaining battery cell modules C2 to C4 either in parallel or in series.

The switching between series and parallel operation is effected in this embodiment example of FIG. 4 and optionally of FIG. 5 inside the battery switching modules or module strings 30, 31, 32, 33 or 40, 41, 42, 43 at the same time. The battery switching modules or module strings can function at the same time or temporally offset. Depending on the operation situation, the two partial electrical systems 21, 22 can thereby be assigned battery capacities based on the situation. The total expense can be optimized by correspondingly adapted dimensioning of the battery cell sizes.

To assess the charge state, the state of health and the functioning and to control the series/parallel switching, a battery management system or a control device for this purpose can be used. For this, current, voltage and temperature sensors can be arranged on the cells, battery cell modules and/or on the inputs and outputs of the battery switching module or module string 30 to 33 or 40 to 43, the signals of which are fed to the battery management system or the control device for this purpose.

Through the provision of the module strings arranged in parallel, the advantage is achieved that a much lower power loss in the individual switches and connection elements results in the case of identical power data, such as in the case of the individual string, because of the distribution of the currents I to the individual module strings 30 to 33 or 40 to 43, as the power loss is proportional to the square of the current I. Accordingly, the respective components of the module strings can also be configured more simply and more cost-effectively.

The modularity of the module strings also has the result that there is a redundancy in the event of failure of one of the module strings, with the result that the other module strings can take over the task or functionality of the failing module string. In the event of failure of a module string, the functionality of the voltage networks can thus also be maintained.

The control unit 50 serves to control the respective module strings, which also controls which and how many of the module strings are connected in the series or in the parallel state.

1. Energy accumulator device for connecting a first voltage network with a first voltage level to at least one second voltage network with a second voltage level, wherein the first voltage level is higher than the second voltage level, wherein there is a plurality of module strings, in each of which a number of battery cell modules (Cx) are provided and interconnected, wherein the module strings can be connected to each other in parallel, wherein in each module string there is a plurality of battery cell modules (Cx) which can be interconnected with each other alternately in parallel or in series via switching elements.

2. The energy accumulator device according to claim 1, wherein the module strings can be connected to each other in parallel, wherein on the input side each module string has a switch by means of which the module string can be switched on.

3. The energy accumulator device according to claim 1, wherein at least two module strings are arranged and can be connected in parallel relative to each other, such as in particular two to four module strings are provided and can be connected to each other in parallel.

4. The energy accumulator device according to claim 1, wherein a control device is provided which monitors a power requirement and the status of voltage networks and, based on the requirement, switches the individual module strings on or off, or dynamically determines the number of module strings switched on or off and controls them accordingly.

5. The energy accumulator device according to claim 1, wherein the battery cell modules (Cx) in a module string can be interconnected with each other in parallel via first switches (Px+, Px−) and can be interconnected with each other in series via second switches (Sx).

6. The energy accumulator device according to claim 4, wherein the control device is formed such that it monitors the power requirement and the status of the voltage networks and, based on the requirement, controls the switches of the individual module strings in order to interconnect the battery cell modules (Cx) with each other in parallel via the first switches (Px+, Px−) and/or to interconnect them with each other in series via the second switches (Sx).

7. The energy accumulator device according to claim 5, wherein the battery cell modules (Cx) or at least individual battery cell modules (Cx) can be coupled to the lower positive voltage level of the second voltage network by means of switches (Px+).

8. The energy accumulator device according to claim 6, wherein the battery cell modules or at least individual battery cell modules can be coupled to the negative voltage level or earthing level of the second voltage network by means of switches (Px−).

9. The energy accumulator device according to claim 7, wherein the first battery cell modules (Cx) can be coupled in series to second battery cell modules (Cx) by means of switches (Sx), wherein a negative terminal of the first battery cell module (Cx) can be connected to a positive terminal of the second battery cell module (Cx−1) by means of the switch (Sx).

10. The energy accumulator device according to claim 8, wherein the first battery cell modules (Cx) are interconnected in series with second battery cell modules (Cx+1) by means of switches (Sx), wherein a negative terminal of the first battery cell module (Cx) can be connected to a positive terminal of the second battery cell module (Cx+1) by means of the switch (Sx).

11. The energy accumulator device according to claim 1, wherein the first voltage network with its first positive voltage level is connected to a battery cell module (C4) between its positive terminal and the switch (P4+).

12. The energy accumulator device in particular according to claim 1, wherein the second voltage network is connected to a battery cell module (C1) directly or via a switch (P1+).

13. An arrangement of energy accumulator devices, characterized in that several energy accumulator devices according to claim 1 are used and are connected to each other with their respective connections to the first or second voltage network.

14. The energy accumulator device according to claim 1, wherein one battery cell module or several battery cell modules is or are in each case assigned a measuring device for a battery cell module current, a battery cell module voltage, individual battery cell voltages, and/or a temperature.

15. The energy accumulator device according to claim 1, wherein a starter, a generator and/or a starter generator is provided in the first and/or in the second voltage network.

16. The energy accumulator device according to claim 1, wherein a further battery which can be connected with its positive terminal to the positive terminal of a battery module (C4) by means of a switch (S4) is provided in the first voltage network.

17. The energy accumulator device according to claim 1, wherein the switches are mechanical or electrical or electronic switches.

18. The energy accumulator device according to claim 1, wherein the switches can be switched by a control device.

19. The energy accumulator device according to claim 1, wherein a DC-to-DC converter is connected to the two voltage networks.

20. A motor vehicle with two voltage networks, with an energy accumulator device according to claim 1 and in particular with a DC-to-DC converter between the two voltage networks.
